(19) United States
(12) Patent Application Publication
(10) Pub. No.: US 2025/0229242 A1
(43) Pub. Date: Jul. 17, 2025

(54) HETEROGENEOUS CATALYTIC REACTORS

(71) Applicant: DIMENSIONAL ENERGY, INC., Ithaca, NY (US)

(72) Inventors: Bradley J. Brennan, Omaha, NE (US); Jason Salfi, Little Compton, RI (US); Howard M. Branz, Boulder, CO (US); Mihir Gada, Tucson, AZ (US)

(73) Assignee: DIMENSIONAL ENERGY, INC., Ithaca, NY (US)

(21) Appl. No.: 18/703,020

(22) PCT Filed: Apr. 17, 2024
(86) PCT No.: PCT/US2022/018266

§ 371 Date: Apr. 19, 2024

Related U.S. Application Data
(60) Provisional application No. 63/257,980, filed on Oct. 20, 2021.

(51) Int. Cl. B01J 8/02; C01B 3/38; C01B 32/40

(52) U.S. Cl. CPC B01J 8/0278; B01J 8/0292; C01B 3/38; C01B 32/40; B01J 2208/00938; C01B 2203/0233; C01B 2203/0238; C01B 2203/0283; C01B 2203/1011

(57) ABSTRACT

Heterogeneous catalytic reactors and methods of their use. The reactors include heat transfer features that help establish a temperature gradient along an axial length of the reactors during use. The inventive reactors also include two or more different species of catalyst materials that are arranged within the reactors such that a given species of catalyst material is positioned at a temperature that will provide for improved or optimal catalytic performance.

### BACKGROUND

The chemical and energy industries rely on fossil fuels as feedstocks, and a majority of the world's plastics and fuels are produced from fossil fuels. The aviation industry, for example, is a significant emitter of carbon dioxide, releasing about 1 gigaton of carbon dioxide in 2019 (˜2.8% of global annual emissions). Aviation requires energy-dense fuels, and the prospect of battery-powered commercial flight are not realistic for at least the next few decades. Some efforts at reducing aviation carbon dioxide emissions include producing fuel from atmospheric carbon dioxide or from man-made sources of carbon dioxide.

A need exists for improved devices, systems, and methods for producing fuel that has industrial applicability, including the powering of aircraft.

### SUMMARY

The present invention is directed towards heterogenous catalytic reactors and methods of using the same.

In some embodiments, the invention includes a heterogeneous catalytic reactor that comprises an encasement, at least one inlet, at least one conduit, at least one outlet, and a plurality of catalytic zones. The encasement has a length, a width, and a depth, where the length extends from a distal portion of the encasement to a proximal portion of the encasement. The encasement defines an internal reaction volume. The at least one inlet is in or extends through the proximal portion of the encasement and defines a reactant flow channel that is in fluid communication with the internal reaction volume of the encasement. The at least one conduit is arranged within the internal reaction volume and extends from the proximal portion of the encasement toward the distal portion of the encasement. The at least one conduit defines a portion of a return flow channel and extends through the proximal portion of the encasement. The at least one outlet defines a portion of the return flow channel. At least two catalyst materials are packed within the internal reaction volume.

In further embodiments, the invention includes methods of producing one or more reaction products. These inventive methods include providing a heterogeneous catalytic reactor as described herein and directing one or more reactants through the reactor. Further, the methods can include establishing a thermal gradient along the length of the internal reaction volume in the encasement of the reactor, wherein a temperature of an internal reaction volume defined by a distal portion of the encasement is higher than a temperature of the internal reaction volume defined by a more proximal portion of the encasement. The methods also include directing one or more reactants through at least one inlet of the reactor and into contact with a first catalyst material held within the reactor. The methods also include directing the one or more reactants through the internal reaction volume towards a distal portion of the encasement, with the one or more reactants increasing in temperature with progression along the length of the internal reaction volume of the encasement of the reactor. The one or more reactants also produce one or more reaction products as the one or more reactants progress along the length of the internal reaction volume of the encasement of the reactor. Further, the methods include directing the reaction product(s) from the internal reaction volume into the at least one conduit. Still further, the methods include directing the reaction product(s) along a return flow channel towards the proximal portion of the encasement. The methods also include transferring heat from the reaction product as it travels along the conduit to a proximal portion of the reactor to the one or more reactants in the internal reaction volume. The methods also include directing the reaction product out of the reactor through the at least one outlet.

This summary is intended to provide an overview of subject matter of the present disclosure. It is not intended to provide an exclusive or exhaustive explanation of the invention. The detailed description is included to provide further information about the present patent application.

### BRIEF DESCRIPTION OF THE DRAWINGS

In the drawings, which are not necessarily, drawn to scale, like numerals may describe similar components in different views. The drawings illustrate generally, by way of example, but not by way of limitation, various embodiments discussed herein.

FIGS. 1A and 1B illustrate a side view and an exploded view, respectively, of an inventive reactor.

FIGS. 1C and 1D illustrate top cut-away views of a conduit of the inventive reactors.

FIG. 1E illustrates a side perspective view of one embodiment of a distal portion of a return flow channel of an inventive reactor.

FIGS. 2A and 2B each illustrate a cut-away side perspective view of embodiments of the present invention that includes baffles.

FIG. 3A illustrates a side cut-away view of one embodiment of the inventive reactors.

FIG. 3B illustrates a side cut-away view of one embodiment of the inventive reactors.

FIG. 4A illustrates a side-view of one version of an inventive reactor.

FIGS. 4B and 4C illustrate a side perspective view and a top-down view, respectively, of an assembly of inventive reactors.

FIG. 5A illustrates a perspective view of a conduit of the present invention.

FIGS. 5B and 5C each illustrate a side view of a reactor of the present invention.

FIG. 6A illustrates a flow chart of a method of the present invention.

FIG. 6B illustrates a side cut-away view of a reactor of the present invention.

FIGS. 7A-7H illustrates various embodiments of the present invention that include conduits and features for increasing heat exchange between the conduit and fluid flowing therein.

FIG. 8 illustrates a side cut-away view of a reactor of the present invention that includes a plurality of different catalyst materials arranged within an internal reaction volume.

### DETAILED DESCRIPTION

The present invention is directed towards heterogeneous catalytic reactors and methods of their use. The inventive reactors are particularly useful in producing precursors for use in the manufacture of sustainable hydrocarbon fuels. For example, the present inventive reactors can be used to produce precursors for sustainable aviation fuel (SAF) using the Reverse Water-Gas Shift reaction (the “RWGS reaction”). The RWGS reaction converts carbon dioxide and hydrogen to carbon monoxide and water according to the reaction shown in Equation 1:

CO₂+H₂→CO+H₂O (Equation 1)

The efficiency of the RWGS reaction improves with increased reaction temperature. The reactors of the present invention can conduct the RWGS reaction (as well as other types of chemical reactions) at relatively hot temperatures with improved thermal efficiencies as compared to prior art reactor designs.

The inventive reactors are also useful in conducting the dry methane reforming reaction shown in Equation 2:

CH₄+CO₂→2CO+2H₂ (Equation 2)

The inventive reactors are also useful in conducting the steam methane reforming reaction shown in Equation 3:

CH₄+H₂O→CO+3H₂ (Equation 3)

As used herein, the terms “catalyst”, “catalytic material”, or the like refer to material which enables a chemical reaction to proceed at a faster rate or under different conditions (e.g., at a lower temperature) than otherwise possible. The catalysts of the present invention may include mixtures of two or more catalytic material(s) with other inert materials. The catalytic materials used in the present invention may be formed into desired shapes or sizes.

As used herein, the term “catalyst zone” or “catalytic zone” refer to portions of an internal reaction volume which exhibit one or more common environmental characteristics, such as the same or similar operating temperatures, same or similar operating pressures, and/or the presence of same or similar catalytic materials.

As used herein, the phrase “direct fluid communication” refers to the ability of a fluid to flow from a first structure or location to a second structure or location without requiring the fluid to flow or migrate through an intermediary structure or location.

As used herein, the term “distal” refers to a feature or aspect of the present invention that is situated away from a point of reference (e.g., a point of attachment, origin, or a central point), while the term “proximal” refers to a feature or aspect of the invention that is situated near that point of reference. Unless indicated otherwise, the point of reference being used herein is generally the end of the inventive reactors that includes the inlet and outlet ports. For example, the end or portion of the inventive reactors that include the inlet and outlet ports may be referred to herein as the “proximal end” or “proximal portion” of the reactor while the opposite end or portion of the reactors (the end that does not include the inlet and outlet ports) may be referred to herein as the “distal end” or “distal portion”.

As used herein, the terms “fluid” or “fluids” refer to a liquid, a supercritical fluid, a gas, or a slurry.

As used herein, the phrase “indirect fluid communication” refers to the ability of a fluid to flow from a first structure or location to a second structure or location but only if the fluid first flows or migrates through an intermediary structure or location to reach the second structure or location.

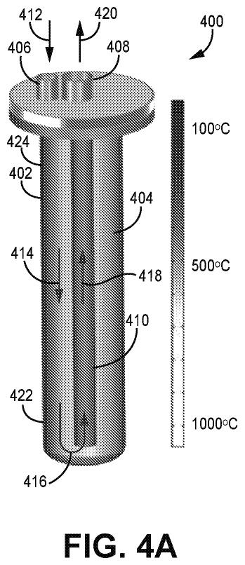

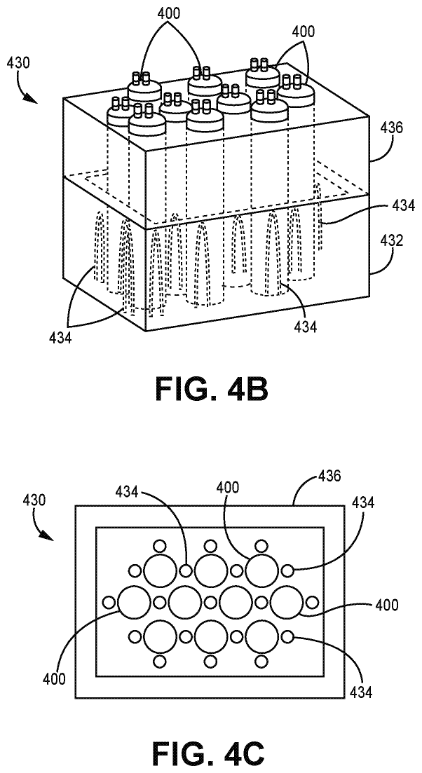

The reactors of the present invention have a “bayonet” design, where the reactant(s) and product(s) enter and exit the reactor from or near the same end and travel in a counter-current flow relative to one another along the length of the reactor. Further, the reactors of the present invention are designed such that a temperature gradient can be established along the length of the reactor during use, with one end (e.g., the proximal end) of the reactor operating at a temperature that is lower than the operating temperature of the opposite end of the reactor (e.g., the distal end). In some cases, the reactant(s) enter and the product(s) leave the cooler end of the inventive reactor, thereby eliminating or reducing the need for expensive heat exchangers. While these concepts will be explained in further detail herein, briefly, FIG. 4A shows a side-view of one version of an inventive reactor in the form of reactor 400. FIG. 4A shows only some of the major components of reactor 400 to better illustrate the bayonet design reactor flow paths and the temperature gradient that can be established in the inventive reactors. One of skill in the art will readily appreciate that the components of the inventive reactors that are not shown in FIG. 4A but are described elsewhere herein are equally applicable to the embodiment of reactor 400.

Reactor 400 includes encasement 402, inlet 406, and outlet 408. Encasement 402 is shown as partially translucent in FIG. 4A to better illustrate the internal structure of reactor 400. Encasement 402 is generally tubular in shape with its internal walls defining internal reaction volume 404. While encasement 402 is generally tubular in shape, in other embodiments the encasements of the present invention take other shapes, such as prismatic, hexagonal, or any other geometry which will promote segregation of heat within the internal reaction volume. Encasement 402 also includes distal portion 422 and proximal portion 424 opposite distal portion 422. Internal reaction volume 404 is the portion or area of reactor 400 in which catalytic reactions occur to convert reactant(s) to product(s) (catalyst materials are not illustrated in FIG. 4A). Internal reaction volume 404 is also defined by the outer walls of return conduit 410. Return conduit 410 is arranged within, and spans most of the length of, encasement 402. A proximal end of return conduit 410 is attached to or otherwise secured against outlet 408 at or near the proximal end of encasement 402, while a distal end of return conduit 410 is positioned at or near the distal end of encasement 402. Collectively, the inner walls of return conduit 410 and outlet 408 define a return flow channel.

With regards to the fluidic flow path of reactor 400, during use one or more fluidic reactants are directed into a proximal portion of reactor 400 through inlet 406 along direction 412. The reactants then travel generally along direction 414 through internal reaction volume 404 along the length, and towards a distal portion, of reactor 400. While traveling through internal reaction volume 404, the reactants contact heterogeneous catalyst materials and undergo catalytic reactions to produce one or more products (e.g., one or more fluidic products). Once in the distal portion of reactor 400, the reactant(s) and/or formed reaction product(s) enter the return flow channel by generally following direction 416 and pass into the distal end of return conduit 410. Return conduit 410 and the return flow channel are devoid of catalyst materials, thus the catalytic conversion of reactant(s) to product(s) decreases or stops once the reactant(s) and/or reaction product(s) enter return conduit 410. The reactant(s) and/or reaction product(s) then flow back up along the return flow channel towards the proximal end of reactor 400 through return conduit 410 along direction 418 and out of reactor 400 via outlet 408 along direction 420.

With regards to the temperature gradient aspect of the inventive reactors, reactor 400 includes distal portion 422 which operates at a temperature that is higher than the operating temperature of proximal portion 424. FIG. 4A includes an exemplary temperature profile to the right of reactor 400 showing an example of an operating temperature gradient that can be present within reactor 400 during use. Proximal portion 424 of reactor 400 is operating at a relatively low temperature (˜100° C.), but the operating temperature of internal reaction volume 404 steadily increases along the length of reactor 400, with distal portion 422 of reactor 400 operating at a relatively high temperature (˜1,000° C.). The temperature profile shown in FIG. 4A is for illustration purposes only, and the actual temperature gradients within the inventive reactors can vary from those shown in FIG. 4A. The operating temperature gradients within the inventive reactors can be a function of heat generated or consumed by a reaction occurring in internal reaction volume 404, heat transferred between the fluids flowing through various parts of reactor 400, and any heat added or removed from reactor 400 via a heating or cooling element.

With regards to heat generated or consumed by a reaction, the catalytic reaction occurring within internal reaction volume 404 may be exothermic or endothermic in nature. If exothermic, the heat generated by the reaction will tend to raise the temperature of reactor 400 and the fluids therein. Conversely, if the catalytic reaction is endothermic in nature, the reaction occurring within internal reaction volume 404 may tend to decrease the temperature of reactor 400 and the fluids therein.

With regards to the transfer of heat between fluid flowing within reactor 400, the fluid flowing through the return flow channel acts as a heat source for the fluids flowing through the internal reaction volume 404. As fluid flows through return conduit 410 from the distal end to the proximal end of reactor 400, the fluid transfers heat to the walls of return conduit 410 and return conduit 410, in turn, conducts that heat energy to the fluid in internal reaction volume 404. While reactor 400 does not illustrate baffles or catalyst materials, if an inventive reactor includes those features the return conduit(s) will also conduct heat into the baffles and catalyst material and the baffles and that heat will in turn be transferred to the fluid that contacts the baffles and/or catalyst material. In this way, the inventive reactors provide for a continuous heat transfer process, with relatively hot fluid in the return conduit(s) transferring heat to the cooler fluid in the internal reaction volume on the opposite side of the return conduit wall. For example, when reactant fluid first enters reactor 400, it is warmed by heat transferred out of the proximal portion of return conduit 410. As that heated reactant fluid continues its journey through internal reaction volume 404 and distally down the length of reactor 400, the reactant fluid is continuously heated by heat transferred out of return conduit 410. When the reactant fluid reaches the distal end of internal reaction volume 404 at the distal end 422 of reactor 400, the reactant fluid, and any product fluid that has been created in the internal reaction volume 404, will be at or near its highest process operating temperature. The hot reactant and product fluid will then travel back towards proximal end 424 of reactor 400 through return conduit 410, and, as it does, the fluid will transfer its heat to the inner walls of return conduit 410. When the reactant and product fluid reaches the proximal end of return conduit 410, the fluid has cooled considerably due to the continual transfer of heat to return conduit 410 and into internal reaction volume 404 as the fluid travelled along the length of return conduit 410.

With regards to heat added or removed from reactor 400, various parts of reactor 400 may be heated or cooled. For example, distal portion 422 and/or proximal portion 424 of reactor 400 may be supplied with heat from an internal or external heat source to add heat and/or increase the temperature of the fluids in internal reaction volume 404 of reactor 400. In another example distal portion 422 and/or proximal portion 424 of reactor 400 may be chilled to remove heat and/or reduce the temperature of fluids in reactor 400.

A plurality of the inventive reactors can be assembled to increase production of reaction product(s) during use. FIGS. 4B and 4C illustrate assembly 430 which includes a plurality of reactors 400. FIG. 4B illustrates a side view of assembly 430, while FIG. 4C illustrates a top view of assembly 430. Assembly 430 includes ten reactors (designated in FIGS. 4B and 4C as “reactor 400”) packed in a hexagonal formation. The distal portion 422 of each reactor 400 is positioned in heating fixture 432 which includes a plurality of heating sources 434 positioned to heat distal portions 422 of reactors 400. The proximal portion 424 of each reactor 400 is positioned within and surrounded by insulation 436, with only the very proximal end of each reactor 400 extending through insulation 436. FIG. 4B shows insulation 436 and heating fixture 432 as partially transparent to better illustrate the arrangement of reactors 400 and heating sources 434. During use, reactant(s) are directed into each reactor 400 via the reactor's inlet 406 while products are directed out of each reactor 400 via the reactor's outlets 408. The distal portion 422 of each reactor 400 is heated by heating sources 434 which in turn heat the distal portion of the internal reactor volume of each reactor 400 to a desired temperature.

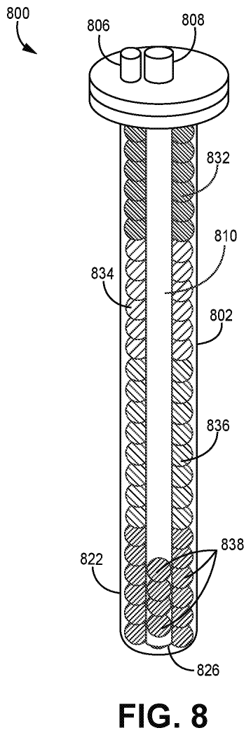

While return conduit 410 is devoid of catalyst materials, in some embodiments the inventive reactors include catalyst materials positioned within a distal portion of a return conduit. The fluids entering the distal portion of a return conduit are generally going to be at or near a maximum process temperature. That is, the fluids in the distal portion of the return conduit are generally at the hottest temperature they will obtain while travelling through an inventive reactor. By including a catalyst material within the hottest distal portion of a return conduit, the heat energy of the reactants can be utilized to drive even further conversion of reactant(s) to product(s). Further, including catalyst materials within a distal portion of a return conduit can increase turbulent flow within the fluids, thereby increasing heat exchange between the fluids and the solid surfaces of the return conduit and/or catalyst materials. FIG. 8 illustrates reactor 800, which is one example of an embodiment of the present invention that includes a plurality of different catalyst materials 832, 834, 836, and 838 arranged within the internal reaction volume defined between the inner wall of encasement 802 and the outer wall of return conduit 810. Catalyst material 838 is also arranged within the inner lumen of the distal portion of return conduit 810. Fluidic reactants enter reactor 800 via inlet 806 and come into contact with the series of catalyst materials 832, 834, 836, and 838 as the fluids travel along the length of reactor 800 through the internal reaction volume. At the distal portion 822 of encasement 802, the fluidic reactants (and resulting product fluids) enter distal end 826 of return conduit 810. The fluidic reactants continue to come into contact with catalyst material 838 arranged within the inner lumen of the distal portion of return conduit 810. The fluid reactants and resulting fluidic products then continue to travel proximally along the inner lumen of return conduit 810 and ultimately exit reactor 800 via outlet 808.

In some embodiments, catalyst materials are positioned within a distal portion of a return conduit, such as the most distal 1%, 2%, 3%, 4%, 5%, 6%, 7%, 8%, 9%, 10%, 11%, 12%, 13%, 14%, 15%, 16%, 17%, 18%, 19%, 20%, 21%, 22%, 23%, 24%, 25%, or more than 25% of the length of the return flow channel defined by a return conduit.

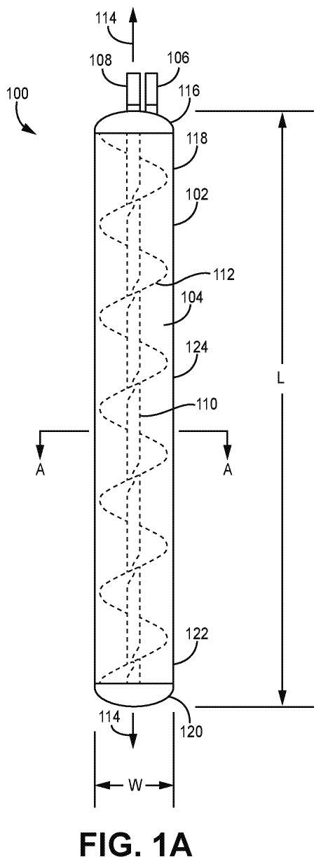

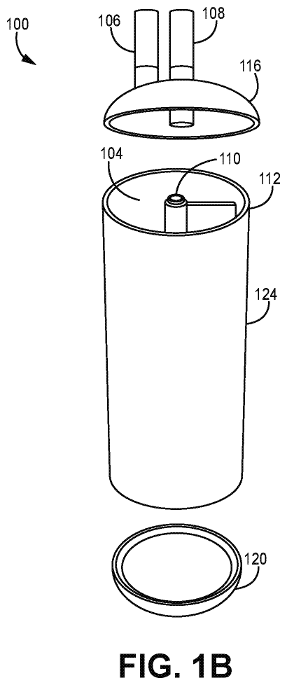

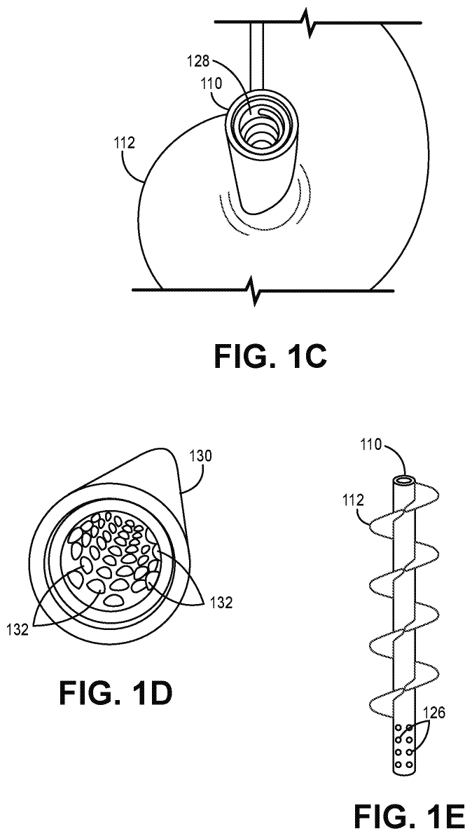

FIGS. 1A and 1B illustrate another embodiment of the invention in the form of heterogenous catalytic reactor 100. FIGS. 1A and 1B illustrate a side view and an exploded view, respectively, of heterogenous catalytic reactor 100. Reactor 100 includes reactor shell or encasement 102, internal reaction volume 104, inlet 106, outlet 108, return conduit 110, and baffle 112. FIG. 1A shows encasement 102 along with certain internal features, though the illustrated internal components or features are shown in phantom (e.g., return conduit 110, and baffle 112).

Encasement 102 is roughly cylindrical in shape, having major axis 114, length L, and width W. Encasement 102 includes cylindrical body 124, proximal cap 116, and distal cap 120. Cylindrical body 124 forms most of the length L of reactor 100, with proximal cap 116 defining one end of proximal portion 118 of reactor 100. Distal cap 120 defines the end of distal portion 122 of reactor 100.

Proximal cap 116 includes two ports in the forms of inlet 106 and outlet 108. While reactor 100 is shown as only having one inlet and one outlet, in some embodiments the reactors of the present invention includes a plurality of outlets and/or inlets (e.g., 2, 3, 4, 5, 6, 7, 8 or more than 8 inlets and/or outlets).

Inlet 106 defines a channel through which one or more reactant species can pass or flow and is in direct fluid communication with the portion of internal reaction volume 104 that is defined within proximal portion 118 of reactor 100. Outlet 108 defines at least a portion of a return flow channel through which one or more product species can pass or flow out of reactor 100. Outlet 108 is in direct fluid communication with a proximal end of return conduit 110.

Internal reaction volume 104 is a space or volume within reactor 100 where the one or more reactants are contacted with one or more species of catalyst materials (not illustrated in FIGS. 1A and 1B) in order to promote or facilitate chemical conversion of the reactants to one or more reaction products. Internal reaction volume 104 is defined by the inner wall of encasement 102 and the outer wall of return conduit 110 and extends along major axis 114 for most of the length L of reactor 100. In proximal portion 118, internal reaction volume 104 is in direct fluid communication with inlet 106. In distal portion 122, internal reaction volume 104 is in direct fluid communication with the distal end of return conduit 110.

Baffle 112 extends into internal reaction volume 104 from return conduit 110. Baffle 112 winds about the exterior of return conduit 110, forming a helical or screw thread-like spiral that extends both radially about and axially along major axis 114 and for at least a portion of length L of reactor 100. Baffle 112 provides a structure that is configured to i) increase convection within fluids directed through internal reaction volume 104 thereby reducing temperature gradients of the fluids flowing through internal reaction volume 104 (e.g., reducing temperature gradients of the fluids along the width W of encasement 102) and ii) function as a heat-sink by transferring heat from return conduit 110 to the fluids that are directed through internal reaction volume 104 as well as any solid materials within internal reaction volume 104 (e.g., catalytic and/or inert filler particles or beads positioned within internal reaction volume 104). In this way, the baffles of the present inventive reactors increase or provide for improved heat transfer between the fluids flowing within a return conduit and the fluids flowing within the internal reaction volume. In some embodiments, the baffles of the inventive reactors extend from or contact the return conduit(s) as well as the inner wall of the reactor encasement.

While baffle 112 is shown in FIG. 1A as having a single-thread helical shape that runs for almost the entire length of return conduit 110, other embodiments of the invention include the use of baffles having different shapes or configurations, such as orifice baffles or segmental baffles. For example, some embodiments of the inventive reactor include baffles with one or more of the following characteristics: i) the baffle(s) may extend along or wind about one or more sub-portions of the length of the internal reaction volume, ii) the baffle(s) may have a helical pitch that varies along one or more sub-portions of the length of the internal reaction volume (i.e., the number of helical windings along some portions of the length of the internal reaction volume may be different than the number of helical windings along other portions of the length of the internal reaction volume), and/or iii) the baffle(s) may have a variable thickness or helical flight width along some portions of the length of the internal reaction volume (i.e., the flight width of a helical baffle along one portion of the length of the internal reaction volume can be different than the flight width along another portion of the length of the internal reaction volume).

Some embodiments of the inventive reactors may include more baffle surface area in some parts of the internal reaction volume than others. By varying the total surface area of the baffles in one portion of the internal reaction volume relative to another, the amount of heat transfer can be increased or decreased in that portion of the internal reaction volume. For example, in some embodiments, the inventive reactors include one or more baffles that extend into a first portion of the internal reaction volume and one or more baffles that extend into a second portion of the internal reaction volume. The total surface area of the baffles extending into the first portion of the internal reaction volume may be larger than the total surface area of the baffles extending into the second portion of the internal reaction volume, thereby increasing the amount of heat transfer between the fluid and materials in the first portion of the internal reaction volume and the fluid travelling within the corresponding length of the return conduit from which the baffles extend.

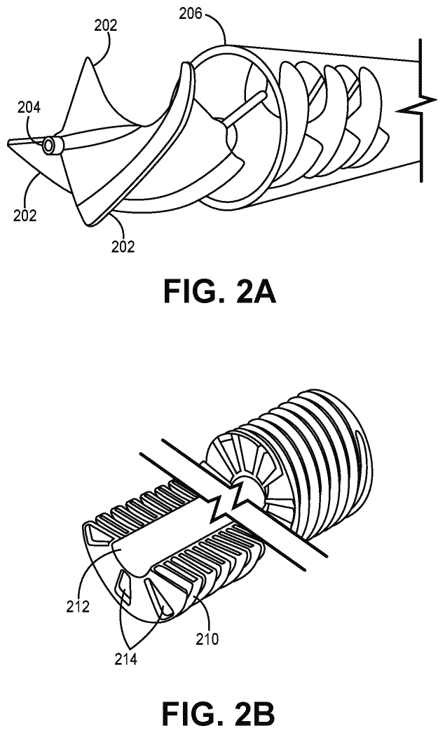

FIG. 2A illustrates a cut-away side perspective view of one embodiment of the present invention that includes a series of baffles 202. Baffles 202 are formed into the shape of a triple-helix that runs along at least a portion of the length of return conduit 204 within encasement 206. Another example of baffle design in the inventive reactors is illustrated in FIG. 2B, which is a perspective side view of baffles 210 and return conduit 212 (note that a portion of baffles 210 are omitted from FIG. 2B to better illustrate the baffle design). Baffles 210 extend from the outer wall of return conduit 212 in a single-thread helical shape, with the baffles defining a plurality of windows 214 through which fluids in an internal reaction volume may travel. Windows 214 provide for a highly torturous flow-path in an internal reaction volume when baffles 210 are arranged within an encasement of an inventive reactor.

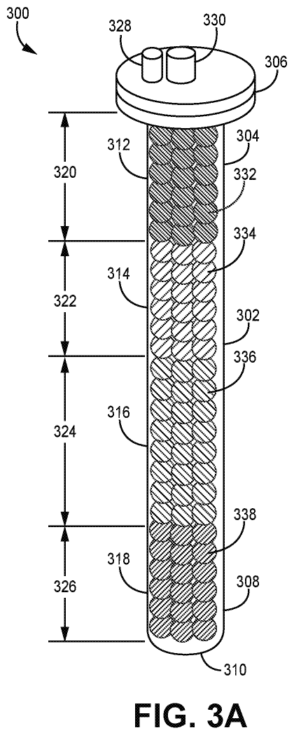

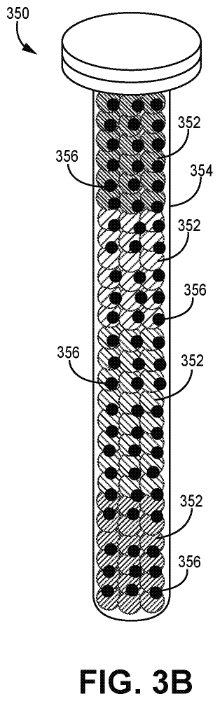

The inventive reactors include one or more species of catalyst materials positioned or arranged within the internal reaction volume. While FIGS. 1A and 1B omit the catalyst materials to improve clarity of the other portions of the inventive reactors, FIG. 3A illustrates a side cut-away view of reactor 300 which shows a plurality of different catalytic species arranged or positioned within the internal reaction volume

Reactor 300 includes encasement 302. Proximal portion 304 of encasement 302 includes proximal cap 306, while distal portion 308 of encasement 302 includes distal cap 310. Proximal cap 306 includes inlet 328 and outlet 330 and defines a proximal end of encasement 302. Outlet 330 is secured to and in direct fluid communication with a return conduit or a manifold joining a plurality of return conduits (not illustrated in FIG. 3A). Inlet 328 is in direct fluid communication with an internal reaction volume bounded by the inner walls of encasement 302 and the outer wall of the one or more return conduit(s).

The internal reaction volume of reactor 300 is filled with four different species of catalyst materials, including first catalyst material 332, second catalyst material 334, third catalyst material 336, and fourth catalyst material 338. Each of first, second, third, and fourth catalyst material 332, 334, 336, and 338 take the form of spherical particles or beads.

While reactor 300 is illustrated with catalyst material 332, 334, 336, and 338 in the form of spherical particles or beads, some embodiments of the inventive reactor may include catalyst material having other forms or shapes. For example, the inventive reactors may include one or more catalyst materials in the form of porous beads, pellets, tubes, Raschig rings, Super Raschig rings, Pall rings, Bialecki rings, extrudates, lobes, saddles, and/or other shapes.

In some embodiments, the catalyst material includes one or more species of catalytically active agents that assist in the conversion of reactant(s) to product(s). The exact type of catalytically active agent in the catalyst material may depend upon the needs of a given application. Some non-limiting examples of potentially suitable catalytically active agents include nickel, zirconia, platinum, palladium, copper, alkali metals, alkaline earth metals, molybdenum, yttria, molybdenum carbide, zinc, iron, chromium, lanthanides, and combinations thereof.

In some embodiments, the catalyst material(s) include one more type of catalyst support material on or in which the catalytically active agent(s) is positioned. The exact type of support material used in the catalyst material may depend upon the needs of a given application, but some non-limiting examples of potentially suitable support materials include metals or non-metal nitrides, carbides, oxides, oxynitrides, oxycarbides, metal alloys, silica, alkaline earth oxides, alkali metal oxides, zirconia, titania, and combinations thereof. Further non-limiting examples of potentially suitable catalyst support materials include alumina (e.g., alpha, beta, delta, theta, gamma, and intermediate phase alumina), silicon carbide (e.g., alpha or beta phase silicon carbide), boron nitride (e.g., hexagonal or cubic phase boron nitride), mullite, steatite, aluminum nitride, aluminum oxynitride, foamed or high-surface area metals (e.g., nickel), silicon, alloys of multiple metals, and composite thereof. In some applications, the support material is, itself, catalytically active and participates in the conversion of reactant(s) to product(s).

First, second, third, and fourth catalyst material 332, 334, 336, and 338 are arranged sequentially, each in their own catalytic zone. First catalyst material 332 is positioned within first catalytic zone 312, which occupies length 320 of the internal reaction volume of encasement 302. Second catalyst material 334 is positioned within second catalytic zone 314, which occupies length 322 of the internal reaction volume of encasement 302. Third catalyst material 336 is positioned within third catalytic zone 316, which occupies length 324 of the internal reaction volume of encasement 302. Fourth catalyst material 338 is positioned within fourth catalytic zone 318, which occupies length 326 of the internal reaction volume of encasement 302.

During operation, a thermal gradient can be established along the length of the internal reaction volume of the inventive reactors such that distal portions of the internal reaction volume operate at a higher temperature than more proximal portions. The catalyst material arranged within each of the catalytic zones can be selected to increase or optimize the performance of the reactor at the temperature and/or pressure of that zone. For example, first catalytic zone 312 may be relatively cool compared to second, third, or fourth catalytic zones 314, 316, and 318, so first catalyst material 332 can be selected to include a material that catalyzes the reactant(s) more efficiently or optimally at that cooler temperature of zone 312. Similarly, fourth catalytic zone 318 may operate at a temperature that is greater than the temperature of the first, second, or third catalytic zones 312, 314, and 316, so fourth catalytic zone 318 can be selected to include a catalyst material that catalyzes the reactant(s) more efficiently or optimally at the higher temperature of zone 318.

The catalyst material arranged within each of the catalytic zones can be selected to meet or exceed a desired performance metric when the inventive reactor is operating at steady state (i.e., the thermal gradients established within the reactor are no longer fluctuating). Examples of such performance metrics include amounts of catalytic conversion or catalytic selectivity. If, for example, an inventive reactor is being used to perform an RWGS reaction, the catalytic material in one or more of the catalytic zones could be chosen to provide a CO₂ conversion of at least 10%, at least 20%, at least 30%, at least 40%, at least 50%, at least 60%, at least 70%, at least 80%, at least 90%, or at least 95%, where CO₂ conversion for a given zone is defined according to the following Equation 4:

$${CO}_{2} Conversion = \frac{Moles of CO Output}{Moles of {CO}_{2} Input} \qquad ( Equation 4 )$$

Yet further, the catalytic material in one or more of the catalytic zones could be chosen to provide a certain fraction of the theoretical conversion maximum for CO₂ under the conditions of a given zone (e.g., the temperature, pressure, and chemical composition within a zone). For example, the catalytic material in a given zone could be chosen to provide at least 10%, at least 20%, at least 30%, at least 40%, at least 50%, at least 60%, at least 70%, at least 80%, at least 90%, or at least 95% of the theoretical conversion maximum for CO₂ under the reaction conditions of that zone.

Alternatively or in addition, the catalytic material in one or more of the catalytic zones could be chosen to provide a catalyst selectivity of at least 80%, at least 85%, at least 90%, at least 95%, or at least 99%, wherein catalyst selectivity for the RWGS reaction is defined for a given zone according to the following Equation 5:

$$catalyst {selectivity}_{RWGS} = \frac{Moles CO output \times 2}{Moles of CO output \times 2 + Moles {CH}_{4} output \times 8} \qquad ( Equation 5 )$$

In some embodiments, each of the catalytic zones comprises, consists essentially of, or consists of a species of catalyst material that is different from or dissimilar to the species of catalyst material arranged or positioned in any of the other catalytic zones. For example, the catalyst materials in a given zone may include different types and/or amounts of catalytic active agents, different types and/or amounts of catalyst support materials, different formulations, different concentrations, and/or different surface areas per given volume, as compared to the catalyst materials in the other catalytic zones. In further examples, the catalyst materials in a given catalytic zone may include different porosity and/or surface area as compared to the catalyst materials in other catalytic zones. In this way, the catalytic active agents and/or catalyst support materials of a given catalytic zone's catalyst material can be tuned to the temperatures and pressures found in that catalytic zone so as to provide for a desirable level of reaction performance.

In some embodiments, each catalytic zone extends along a portion of the length of the internal reaction volume of the encasement while occupying the entire width of that portion of the encasement. That is, in some embodiments of the invention, each catalytic zone can be arranged within the encasement such that there is no overlap between neighboring zones along the length of the internal reaction volume of the reactor and/or along the temperature gradient within the inner reaction volume of the reactor. In this way, some embodiments of the present reactor include only one species of catalyst material at a given reaction temperature.

While FIG. 3A illustrates an embodiment of the invention that includes four different catalytic zones, some embodiments of the invention includes a plurality of catalytic zones (e.g., 2, 3, 4, 5, 6, 7, 8, 9, 10, 11, 12, 13, 14, 15, 16, 17, 18, 19, 20, 21, 22, 23, 24, 25, 26, 27, 28, 29, 30, or more than 30 catalytic zones), each with its own specific composition and/or concentration of catalyst material having characteristics desirable for that zone (e.g., surface area, selectivity, specificity, kinetics, thermodynamics, pore size, thermal conductivity, thermal stability, chemical stability, or other catalytic characteristics). The different species of catalyst materials can be arranged in a predetermined sequential order with the performance characteristics of that species of catalyst material matched or paired with the operating conditions (e.g., temperature and/or pressure) in its respective catalytic zone. For example, catalyst material that provide better performance for a given reaction at relatively high temperatures can be positioned in catalytic zones near or at the distal end of the internal reaction volume of the reactor while catalysts better suited for lower operating temperature can be positioned in catalytic zones near the proximal portion the internal reaction volume of the reactor.

In some embodiments the support material for the catalyst includes a porous coating, such as porous coatings of silicon carbide and/or boron nitride. Such a porous coating can allow the infiltration of reactant fluids while also allowing for improved heat transfer among and between the catalyst particles and the fluids in the internal reaction volume. In some embodiments, the catalyst material is arranged within the pores of the support structure to increase the active surface area of the catalyst.

In some embodiments, the reactors of the present invention include inert filler particles (e.g., filler beads) that are distributed or arranged within the internal reaction volume. FIG. 3B illustrates one such embodiment in the form of reactor 350 (note parts of the inventive reactor, such as inlets or outlets, are omitted in FIG. 3B for brevity). Reactor 350 includes encasement 354 which defines an internal reaction volume that includes a plurality of different bead-shaped catalyst materials 352 as well as a plurality of inert filler beads 356 positioned or arranged about the bead-shaped catalyst materials 352. Inert filler beads 356 may be made of a material that promotes conductive heat transfer (e.g., silicon carbide, alumina, boron nitride, copper, stainless steel, aluminum, aluminum nitride, aluminum oxynitride, and/or composites thereof). Inert filler beads 356 can assist in or improve the transfer of heat within the internal reaction volume, thereby helping to maintain a more uniform temperature gradient across the width of reactor 350. In some embodiments, up to 5%, 10%, 15%, 20%, 25%, 30%, 35%, 40%, 45%, or 50% of the volume of the internal reaction volume may be occupied by inert filler beads.

Turning back to reactor 100 illustrated in FIGS. 1A and 1B, reactor 100 includes return conduit 110. Return conduit 110 takes the form of a tube that extends within internal reaction volume 104 along length L of encasement 102. Return conduit 110 is positioned within internal reaction volume 104 roughly coaxially with major axis 114. The proximal end of return conduit 110 is secured to or positioned next to outlet 108 of proximal cap 116 in proximal portion 118 of encasement 102. The distal end of return conduit 110 includes a plurality of perforations or holes 126 through which fluid can pass to enter the lumen defined by return conduit 110, as best shown in FIG. 1E. In this way, holes 126 prevent larger solid matter (e.g., catalyst material or inert filler beads) from entering the lumen defined by return conduit 110.

Return conduit 110 and outlet 108 each define a portion of a return flow channel through which fluids (e.g., reactants and/or reaction products) can be directed to leave reactor 100. As the fluids pass through return conduit 110, heat from the fluid is conducted through the wall of return conduit 110 and baffles 112 and into the catalyst material, optional inert particles, and fluid that is present in the internal reaction volume 104. In this way, heat is transferred from the fluid that is on its way out of the reactor 100 (i.e., fluid that is directed through the return flow channel) and into the fluid that is travelling towards distal portion 122 of encasement 102 (i.e., fluid that is flowing through internal reaction volume 104).

Return conduit 110 can include features to promote turbulent fluid flow within its lumen to decrease temperature gradients across the radial width of return conduit 110 and to improve the heat transfer from the fluid inside return conduit 110 to the fluid in internal reaction volume 104. FIG. 1C illustrates a top cut-away view of return conduit 110 along plane AA of FIG. 1A (FIG. 1C omits the walls of encasement 102 for clarity). As can be seen in FIG. 1C, return conduit 110 includes a raised helical groove or rifling 128. Groove or rifling 128 winds about the circumference of the inner wall of return conduit 110 and extends in a helical shape from the distal end to the proximal end of return conduit 110. As reactant(s) and/or product(s) fluids flow through return conduit 110, rifling 128 increases turbulence in the fluids thereby decreasing any gradient in temperature that may exist along the radial width of return conduit 110. This in turn, promotes or increases heat transfer to baffle 112 and to the materials in internal reaction volume 104 (e.g., fluids, catalyst material, and/or inert beads). While return conduit 110 includes a groove or rifling 128 to increase flow turbulence, other embodiments of the invention may use other types of surface texturing such as non-helical grooves, bumps, non-helical ridges, or other forms of baffling that function to increase turbulence and thereby improve heat transfer from the fluid in a return conduit to the materials in an internal reaction volume (e.g., the reactant/product fluids, catalyst materials, or inert particles). FIG. 1D illustrates a top cut-away view of return conduit 130, which is a return conduit of another embodiment of the invention that includes a plurality of small dimples or bumps 132 formed in or positioned on the inner wall of return conduit 130. Bumps 132 act as baffles to promote turbulent flow within the lumen defined by return conduit 130.

While reactor 100 is shown as having a single return conduit 110 in the configuration of a single straight tube or channel running along major axis 114 across most of the length L of encasement 102, other embodiments of the invention include return conduits having different shapes and configurations. For example, reactors of the present invention may include a return conduit having a helical or spiral shape or a return conduit with more than one channel. Using a helical shaped return conduit or a return conduit with more than one channel can provide for improved heat transfer from the fluid in the return conduit channel to the fluid in an internal reaction volume by providing a longer return flow channel pathway and/or by decreasing the radius or width of the return conduit channels. In some embodiments of the invention, the reactors do not include baffles extending from return conduit channels because such bafflers are not needed to achieve adequate heat transfer between the fluid in the return conduit and the fluid in the internal reaction volume.

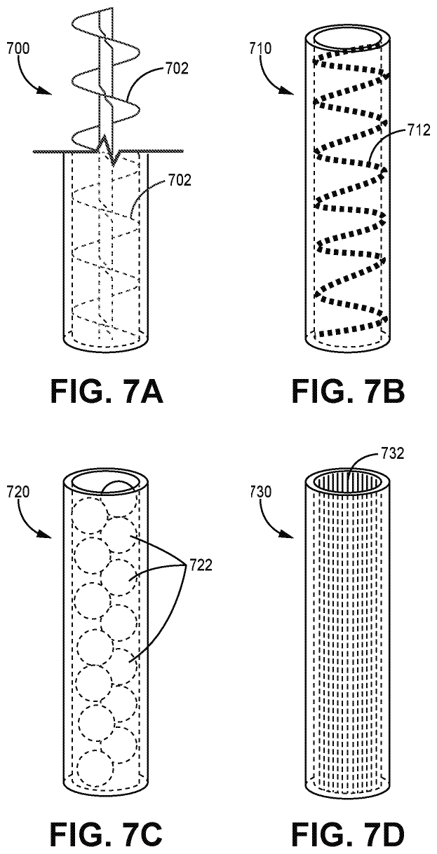

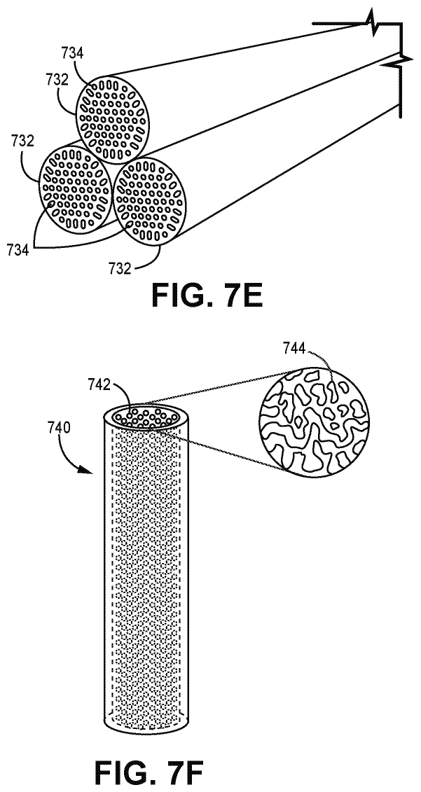

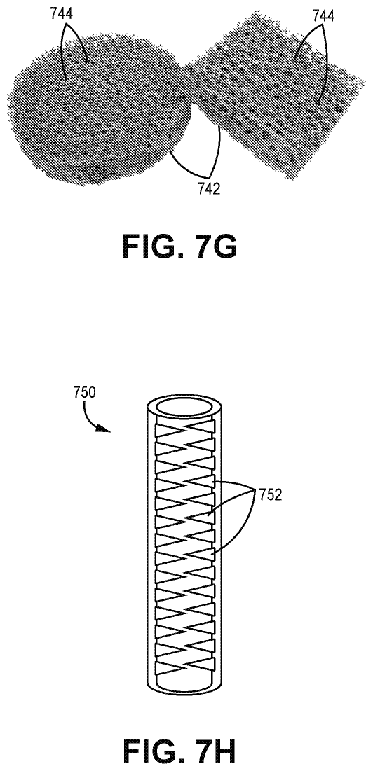

In some embodiments, the inventive reactors include return conduits which include features for increasing convective and/or conductive heat exchange between the return conduit and the fluid flowing within the return conduit. For example, the return conduits can contain packing materials that increase the turbulence of the fluid traveling through the return conduits and/or the inner wall surfaces of the return conduits can include features that increasing turbulent flow within the fluids traveling within the return conduits, thereby increasing the convective heat exchange between the fluids and the surfaces of the return conduits and/or packing within the return conduits. Further, the packing materials within the return conduits and/or the features formed on the inner walls of the return conduits can transfer heat to the other portions of the return conduit and/or packing materials within the other parts of the internal portions of the inventive reactors (e.g., the internal reaction volume). Various examples of such features are illustrated in FIGS. 7A-7H.

FIG. 7A illustrates a side view of a portion of return conduit 700. The illustration of FIG. 7A is shown as partially transparent to better illustrate the interior features of return conduit 700. Return conduit 700 includes helical baffle 702 winding about the inner wall of return conduit 700. Helical baffle 702 is in physical contact with the inner wall of return conduit 700, thereby providing for a high degree of thermal connectivity between return conduit 700 and helical baffle 702. During use, helical baffle 702 will induce turbulence in the flow of product and reactant fluids as they travel through return conduit 700, thereby increasing heat transfer from the fluids to helical baffle 702 and thereby to the inner wall of return conduit 700.

FIG. 7B illustrates a side view of a portion of return conduit 710. The illustration of FIG. 7B is shown as partially transparent to better illustrate the interior features of return conduit 710. Return conduit 710 includes helical coil 712 winding about the inner wall of return conduit 710. Helical coil 712 is in physical contact with the inner wall of return conduit 710, thereby providing for a high degree of thermal connectivity between return conduit 710 and helical coil 712. During use, helical baffle 712 will induce turbulence in the flow of product and reactant fluids as they travel through return conduit 710, thereby increasing heat transfer from the fluids to helical coil 712 and the inner wall of return conduit 710.

Helical baffle 702 and helical coil 712 are similar in many ways in that they each wind along the inner circumference of their respective return conduits. One difference between helical baffle 702 and helical coil 712 is how far radially they extend towards the central axis of the lumen defined by their respective return conduits. Helical baffle 702 spans the entire radial distance to the central axis of return conduit 700, while helical coil 712 spans only a partial way to the central axis of return conduit 710.

FIG. 7C illustrates return conduit 720 in which is positioned a plurality of particles in the form of spherical beads 722. The interstitial spaces between the beads form a tortuous path through which product and reactant fluid will flow during use. This tortuous path induces turbulence in the flow of product and reactant fluids as they travel through return conduit 720. Beads 722 are in direct physical contact with neighboring beads and the inner wall of return conduit 720, which provides for increase heat exchange both via conduction between the beads and the inner walls of the return conduit 720 as well as convection between the fluids traveling through return conduit 720. Spherical beads 722 can be particles (e.g., pressed and/or polished particles) of silicon carbide, boron nitride, silicon nitride, alumina, aluminum, aluminosilicate, steatite, magnesium oxide, copper, aluminum nitride, aluminum oxynitride, and/or stainless steel. While FIG. 7C illustrates return conduit 720 packed with spherical beads 722, in some embodiments of the invention the return conduits are packed with particles shaped as spheres, pellets, lobes, hollow tubes, ribbons, wires, Rasching rings, cross rings, saddles, tri-y rings, random shapes, or combinations thereof.

FIG. 7D illustrates return conduit 730 in which is positioned monolith 732 that includes a plurality of small linear channels 734. Alternatively, monolith 732 and return conduit 730 are formed as a unitary structure. Monolith 732 and/or return conduit 730 may be formed from a ceramic material and/or an extruded metallic material. FIG. 7E illustrates a top cut-away view of three monoliths 732 showing a better view of the plurality of small linear channels 734. During use, monolith 732 is arranged within, and is in contact with the inner wall of, return conduit 730 and the product and reactant fluids traverse along return conduit 730 by flowing through the plurality of linear channels 734 of monolith 732. The fluids transfer heat to the bulk material of monolith 732, and the bulk material of monolith 732 in turn conductively transfers the heat to the inner wall of return conduit 730 and thereafter into the internal reaction volume. In some embodiments, baffles may be formed about the exterior of the return conduit (as described elsewhere herein) and a monolith may be placed or formed within the return conduit.

FIG. 7F illustrates return conduit 740 in which is positioned foam monolith 742 that includes a network of random channels or interconnected pores forming a highly tortuous fluidic flow route or flow path 744 through return conduit 740. Foam monolith 742 may be made of a ceramic material, a metal material, or both ceramic and metal materials. FIG. 7G illustrates a photograph showing cross-section profiles of two portions of foam monolith 742, which show another view of the highly tortuous fluidic flow path 744 therethrough. During use, foam monolith 742 is arranged within, and is in contact with the inner wall of, return conduit 740 and the product and reactant fluids traverse along return conduit 740 by flowing through the highly tortuous fluidic flow paths 744 defined within foam monolith 742. The fluids transfer heat to the bulk material of foam monolith 742, and the bulk material of foam monolith 742 in turn transfers the heat conductively to the inner wall of return conduit 740.

FIG. 7H illustrates return conduit 750 which includes a plurality of spikes or appendages 752 jutting from the inner wall of return conduit 750 and towards the central axis of return conduit 750. During use, appendages 752 induce turbulence in the reactant and product fluids as they flow through the inner lumen of return conduit 750. The fluids transfer their heat to the bulk material of appendages 752 and appendages 752 in turn transfer that heat conductively to return conduit 750.

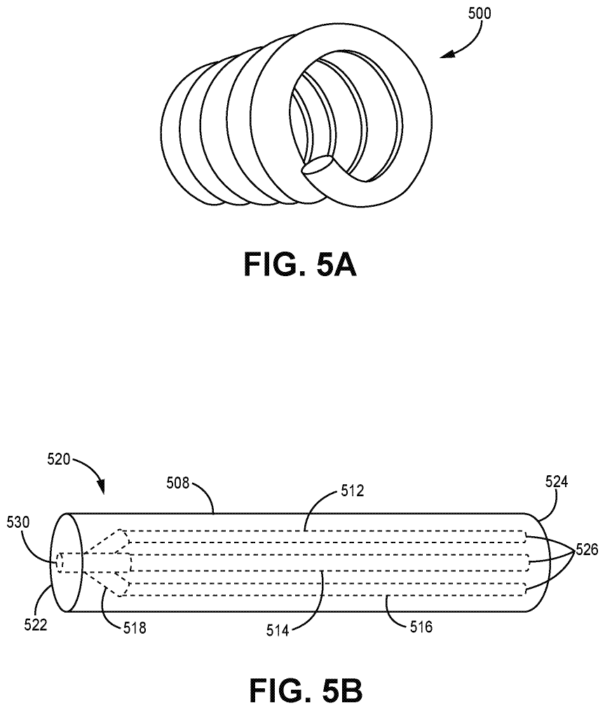

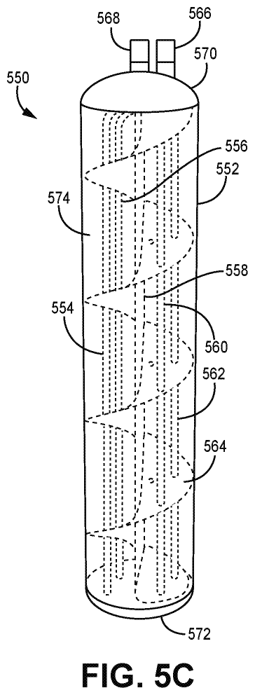

FIGS. 5A-5C illustrate various forms of return conduits of the invention, including a return conduit having a helical shape and embodiments utilizing a return conduit with more than one channel.

FIG. 5A illustrates a perspective view of return conduit 500 having a single helix or spiral configuration. The “internal reaction volume” of an inventive reactor that includes return conduit 500 would include not only the space or volume between the inner walls of the encasement and the outer helical radius of return conduit 500, but also the space or volume within the inner helical radius of return conduit 500 (i.e., the volume that extends along the central axis of return conduit 500 and is bounded by the inner circumferences of the helical spiral). Catalyst material can be packed both around and within the helical structure of return conduit 500. The relatively long, winding return flow path defined by return conduit 500 can provide an adequate amount of heat transfer between the fluids within return conduit 500 and the fluid within an internal reaction volume without the use of baffles extending from the outer surface of return conduit 500.

FIG. 5B illustrates a simplified side view of reactor 520 of the present invention that includes multiple return conduits (return conduits shown in phantom). For simplicity, FIG. 5B omits a number of elements found in reactors of the present invention and illustrates encasement 508 as partially transparent so as to better illustrate the return conduit structure within reactor 520.

Reactor 520 includes encasement 508, first return conduit 512, second return conduit 514, third return conduit 516, and return manifold 518. First, second, and third return conduits 512, 514, 516 extend along most of the length of internal reaction volume 574 of encasement 508, generally parallel to one another. Distal ends 526 of first, second, and third return conduits 512, 514, 516 are positioned in a distal portion of reactor 520 near distal end 524 of encasement 508. The proximal ends of first, second and third return conduits 512, 514, 516 are all secured to return manifold 518, and return manifold is in turn secured to proximal end 522 of encasement 508. In operation, fluid flows from an inlet in proximal end 522 (inlet not shown in FIG. 5B), down the length of encasement 508 and through internal reaction volume 574 defined by the inner walls of encasement 508 the outer walls of return conduits 512, 514, 516. The fluid then enters distal ends 526 of first, second, and third return conduits 512, 514, 516. From there, the fluid travels back up first, second, and third return conduits 512, 514, 516, flows into return manifold 518, and out of reactor 520 via outlet 530 attached to a proximal end of return manifold 518.

FIG. 5C illustrates a simplified side view of reactor 550 of the present invention that also includes multiple return conduits. For simplicity, FIG. 5C omits catalyst materials and illustrates certain structures within encasement 552 in phantom (e.g., first, second, third, fourth, and fifth return conduits 554, 556, 558, 560, and 562 and baffle 564) to better illustrate the return conduit structure within reactor 550.

Reactor 550 includes encasement 552, first return conduit 554, second return conduit 556, third return conduit 558, fourth return conduit 560, fifth return conduit 562, baffle 564, inlet 566, and outlet 568. First, second, third, fourth, and fifth return conduits 554, 556, 558, 560, 562 extend along most of the length of internal reaction volume 574 of encasement 552, generally parallel to one another. The distal ends of first, second, third, fourth, and fifth return conduits 554, 556, 558, 560, 562 are positioned in a distal portion of reactor 552 near distal end 572 of encasement 552. The proximal ends of first, second, third, fourth, and fifth return conduits 554, 556, 558, 560, 562 are all secured to a return manifold (not visible in FIG. 5C) which is in turn secured to outlet 568. Outlet 568 and inlet 566 extend through proximal end 570 of encasement 552. Third return conduit 558 is positioned roughly along the central axis of encasement 552. Helical baffle 564 projects radially off of and winds about third return conduit 558, extending along the longitudinal length of encasement 552 from proximal end 570 to distal end 572. First, second, fourth, and fifth return conduits 554, 556, 560, 562 are positioned symmetrically around third return conduit 558 and also extend longitudinally along the length of encasement 552 from proximal end 570 to distal end 572.

In operation, fluid reactant(s) enters reactor 550 via inlet 566 and flows from proximal end 570, down the length of encasement 552 and internal reaction 574 volume defined by the inner walls of encasement 552 and the outer walls of first, second, third, fourth, and fifth return conduits 554, 556, 558, 560, 562. Once the fluid reactant(s) and the formed product(s) reach distal end 572, the fluids enter the distal ends of first, second, third, fourth, and fifth return conduits 554, 556, 558, 560, 562. From there, the fluid travels back up first, second, third, fourth, and fifth return conduits 554, 556, 558, 560, 562, and flows into the return manifold and out of reactor 550 via outlet 568 extending through proximal end 570.

Because reactor 520 and reactor 550 use more than one return conduit channel, each of their respective return conduits can have a smaller diameter as compared to a reactor that utilizes only a single conduit. Further, the spacing between each of the plurality of return conduits allows the fluids in internal reaction volume 574 to surround each of the conduits. The smaller return conduit diameters and the spaced apart nature of the plurality of conduits facilitate more efficient heat transfer from the fluid within each return conduit to the fluid in internal reaction volume 574.

While reactor 520 is illustrated with three branched return conduits and reactor 550 is illustrated with five branched return conduits, some embodiments of the inventive reactors include 2, 4, 6, 7, 8, 9, 10, or more than 10 return conduits. Further, while reactor 520 illustrates return conduits 512, 514, 516 all merging into return manifold 518, some embodiments of the inventive reactors forgo the use of a return manifold entirely and simply have a plurality of outlets with each outlet joined to its own dedicated return conduit. In still further embodiments, the inventive reactor has both branched return conduits merging into a return manifold and one or more return conduits with their own dedicated outlets.

The materials of construction used to make the inventive reactors can be chosen based upon the demands and performance characteristics required for a given application. Some factors that should be considered in choosing materials of construction include thermal stability, chemical reactivity, thermal conductivity, resistance to cracking, and cost. RWGS reaction applications are particularly demanding, as the carbon monoxide produced by the RWGS reaction tends to attack and corrode iron and nickel alloys in various temperature ranges, producing toxic products. In some embodiments, the reactors of the present invention operate with, and are made of material(s) that can withstand, internal operating temperatures (i.e., temperatures within the reactor encasement) of between about 50° C. and about 1,600° C. and/or external operating temperatures (i.e., temperatures on the outer surface of the reactor encasement) of between about 50° C. and about 2,000° C.

In some embodiments, the inventive reactors or portions of the inventive reactors are made of a metal or a metal alloy (e.g., a stainless steel alloy, such SS316, or a chromium nickel alloy, such as 800HT and/or TMA6301), a ceramic material, a ceramic composite material, or combinations thereof. Silicon carbide, silica, aluminum nitride, aluminum oxynitride, and/or alumina, for example, can be used to form some or all of the components of the inventive reactors. Silicon carbide is a relatively strong material with advantageous thermal conductivity properties. Silicon carbide also has relatively low gas permeability and excellent chemical stability, a low thermal expansion coefficient, and is resistant to fracture and crack propagation.

In some embodiments, the inventive reactors are made of two or more materials to better accommodate the temperature gradient that may span along the length of the reactor during use. For example, a distal portion of the reactor may operate at a relatively high temperature (e.g., 900° C.-1,600° C.) while a proximal portion of the reactor operates at a relatively low temperature (e.g., 50° C.-400° C.). The distal portions of the reactor can be formed from a material that is better able to handle the higher temperatures (e.g., a ceramic material or a ceramic composite material, such as silicon carbide), while more proximal portions may be made of materials that do not need to withstand those higher temperatures (e.g., a metal or metal alloy). For example, the inlet(s) or outlet(s) tubes of an inventive reactor may be formed of a metal or metal alloy, while the manifold and/or return conduit(s) and/or encasement may be formed of silicon carbide material, a silicon carbide composite, alumina, silica, aluminum nitride, aluminum oxynitride, or combinations thereof. In some embodiments, one or more portions of the inventive reactors (e.g., the inlet/outlet tubes, encasement, return conduits, etc.) have a proximal end that is formed from one or more of the metals described herein, a distal end that is formed from one or more of the ceramic or ceramic composite materials described herein, and an intermediate portion therebetween that is formed from a mixture of both the metal and the ceramic material. In some embodiments, the ratio of the two materials in the intermediate portion can vary along the longitudinal length of the reactor portion. For example, an inlet tube can have a metal proximal portion and a ceramic distal portion and, between those two portions, an intermediate portion where the ratio of metal to ceramic gets larger near the distal end and smaller near the proximal end. The gradual transition from metal to ceramic along the intermediate portion can reduce the likelihood of stress fractures forming in the inventive reactor during use and/or installation.

Further, some portions of the inventive reactor may be coated, lined, or impregnated with a second material so as to impart improved operating performance and/or endurance to the reactor. For example, all or some portion (e.g., a distal portion) of an encasement may include a lining or coating of aluminide, alumina, an alumina/silicon carbide composite material, a boron nitride material, mullite, a silicon nitride material, a rare-earth silicate material, or a rare-earth aluminate material.

Manufacturing methods useful for making the various components of the inventive reactors include machining, casting, molding, forming, joining, plating, isopressing, extruding, or additive manufacturing methods (e.g., binder jet 3D printing methods, extrusion 3D printing methods, stereolithography methods, robocasting methods, or selective laser sintering methods). Further, methods such as solid-state sintering, liquid-phase sintering, reactive melt infiltration, chemical vapor infiltration, and phenolic impregnate pyrolysis can be used to consolidate printed preforms into dense, usable parts of the inventive reactors.

A 3D printing process can be used to print all or portions of the components of the inventive reactors using one or more different types of materials. For example, a 3D printing process can be used to print two or more portions of a return conduit tube out of silicon carbide and then the two or more portions can be sintered together to create the finished return conduit tube. In another example, a 3D printing process can be used to print a distal portion of a return conduit out of silicon carbide and a proximal portion out of a metal alloy and then the two portions are welded or otherwise adhered together to form the complete return conduit tube. A 3D printing process that utilizes two or more materials and can vary the ratio of those materials across the dimensions of a workpiece can also be useful in creating the inventive reactors or portions of the inventive reactors. For example, a 3D printing process can be used to print a return conduit tube having a distal portion made of a first material (e.g., a ceramic or silicon carbide material), a proximal portion made of a second material (e.g., a metal alloy), and intermediate portions made of a mixture of the first and second materials.

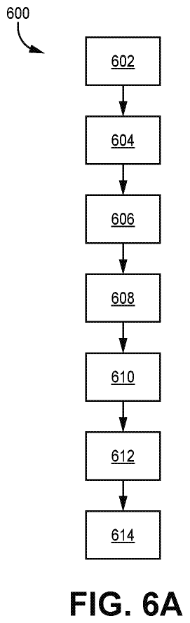

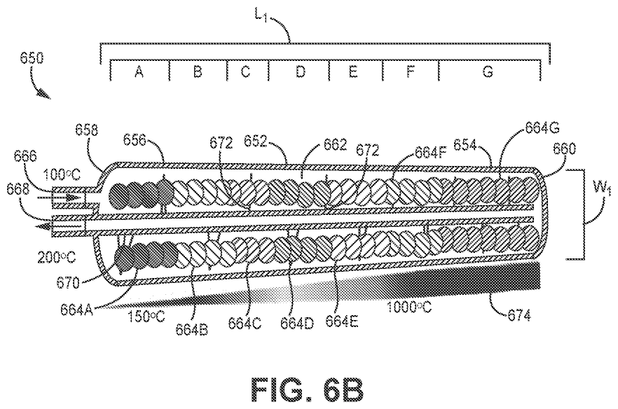

In some embodiments, the invention includes methods of producing a reaction product using one of the inventive reactors described herein. FIG. 6A illustrates a flow chart showing method 600 which is one embodiment of an inventive method of producing a reaction product. FIG. 6B illustrates a cutaway view along the axial length of reactor 650, which will be referred to as method 600 is described.

Part 602 of method 600 includes providing a heterogeneous catalytic reactor, such as one of the inventive reactors described herein. Reactor 650 shown in FIG. 6B illustrates such a reactor. Reactor 650 includes encasement 652 which is generally cylindrical in shape, with length L₁ that is greater than its width W₁. The length L₁ of encasement 652 extends from proximal end cap 658 at one end of proximal portion 656 to distal end cap 660 at the end of distal portion 654.

Encasement 652 defines internal reaction volume 662. Encasement 652 encloses a plurality of catalyst materials 664A, 664B, 664C, 664D, 664E, 664F, and 664G within volume 662 (in the form of catalyst spheres). Catalyst materials 664A, 664B, 664C, 664D, 664E, 664F, and 664G are arranged sequentially along length L₁, with each species of catalyst materials arranged in its own catalytic zone (each of the seven catalytic zones are enumerated in FIG. 6B as lengths A, B, C, D, E, F, and G). Specifically, catalyst material 664A is arranged within catalytic zone A, catalyst material 664B are arranged within catalytic zone B, catalyst material 664C are arranged within catalytic zone C, catalyst material 664D are arranged within catalytic zone D, catalyst material 664E are arranged within catalytic zone E, catalyst material 664F are arranged within catalytic zone F, and catalyst material 664G are arranged within catalytic zone G. Each of catalysts materials 664A, 664B, 664C, 664D, 664E, 664F, and 664G are selected to optimize the performance of the reactor at the temperature and/or pressure of its respective catalytic zones A, B, C, D, E, F, and G.

Reactor 650 also includes inlet 666 and outlet 668 which both extend through proximal end cap 658, though in alternative embodiments the reactor includes more than one inlet and/or outlet (e.g., 2, 3, 4, 5, 6, 7, 8, 9, 10, or more than 10 inlets and/or outlets). Return conduit 670 is positioned within encasement 652 and extends along most of length L₁ from proximal end cap 658 towards distal end cap 660. Helical baffle 672 extends from return conduit 670 into internal reaction volume 662.

Outlet 668 and the inner walls of return conduit 670 define a return flow channel. Inlet 666 is in direct fluid communication with internal reaction volume 662 and indirect fluid communication with the return flow channel. Outlet 668 is in direct fluid communication with the portion of the return flow channel that is defined by the inner walls of return conduit 670 and indirect fluid communication with internal reaction volume 662 and inlet 666.

Part 604 of method 600 includes establishing a thermal gradient along length L₁ of internal reaction volume 662 within encasement 652. FIG. 6B provides temperature gradient 674, which indicates the temperature of the internal reaction volume 662 as a function of distance along length L₁ after the thermal gradient has been established (i.e., at steady state operation of reactor 650). As shown, proximal portion 656 of encasement 652 operates at a temperature of about 150° C. while distal portion 654 of encasement 652 operates at a temperature of about 1,000° C. Establishing a thermal gradient can include directing a heated fluid through inlet 666, heating or cooling distal portion 654, and/or allowing heat generated or consumed by reaction(s) occurring in internal reaction volume 662 to continue until the temperature gradient within encasement 652 comes to an equilibrium.

Part 606 of method 600 includes directing one or more reactants through the at least one inlet of the inventive reactor. In the context of FIG. 6B, part 604 includes directing reactant(s) through inlet 666 and into internal reaction volume 662 of reactor 650. The exact type and quantity of reactants will vary with a given application. However, in some embodiments, the reactants include one or more of hydrogen, methane, carbon dioxide, and water. In some embodiments of the invention, fluidic carbon dioxide and hydrogen at a temperature of about 100° C. are directed through inlet 666 and into contact with catalytic material 664A positioned within catalytic zone A in internal reaction volume 662. Once in contact with catalytic material 664A, at least some of the reactants are converted to the reaction products. The exact type and quantity of resulting reaction products will also vary with a given application. However, in some embodiments, the reaction products can include one or more of carbon monoxide, water, and hydrogen.

Part 608 of method 600 includes directing the one or more reactants further through internal reaction volume 662 towards distal portion 654 of encasement 652. Baffle 672 heats and promotes turbulent flow within the fluidic reactants as they traverse through internal reaction volume 662 along length L₁ of encasement 652. Further, reactants contact the other species of catalyst material 664B, 664C, 664D, 664E, 664F, and 664G positioned in their respective catalytic zones B, C, D, E, F, and G. Hence, as the fluidic reactants progress along length L₁ of encasement 652, the temperature of the reactants and catalyst materials increases and the reactants continue to contact catalytic species that further convert reactants to reaction product fluids (e.g., carbon monoxide, water, hydrogen, etc.).

Part 610 of method 600 includes directing the reaction products as well as any unreacted reactants from internal reaction volume 662 and into the distal end of return conduit 670. Return conduit 670 defines a portion of the return flow channel which provides a flow path for the reaction products (and unreacted reactants) to leave reactor 650.

Part 612 of method 600 includes directing the fluidic reaction products along the return flow channel towards proximal portion 656 of reactor 650. As the fluidic reaction products traverse length L₁ of encasement 652 via return conduit 670, the fluidic reaction products transfer heat to return conduit 670 and that heat is in turn transferred to baffle 672 and the fluid within internal reaction volume 662.

Part 614 of method 600 includes directing the fluidic reaction products through at least one outlet 668. In the case of reactor 650, the fluidic reaction products flow through outlet 668 to leave reactor 650.

As shown by temperature gradient indicator 674, the fluidic reactants and reaction products increase in temperature as they traverse distally along length L₁ within reactor 650 and its internal reaction volume 662. At proximal end cap 658, the temperature of the reactants and products are relatively low, with the reactants entering inlet 666 at a temperature of about 100° C. and gradually increase to a temperature equal to or greater than 1,000° C. once the reactant fluid reaches distal end cap 660. The product fluids (and any unreacted reactant fluids) then enter the distal end of internal reaction volume 662 at a temperature equal to or greater than 1,000° C. but decrease in temperature as they traverse proximally back along length L₁ through the length of return conduit 670. By the time the product fluids (and any unreacted reactant fluids) reach outlet 668, they have been cooled to a temperature of about 200° C. In this way, the proximal portion 656 of reactor 650 operates at a significantly lower temperature than distal portion 654.

In some embodiments of the invention, a separate heat exchanger (not illustrated) could be used to preheat the fluidic reactants shortly before they enter inlet 666.

The scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto.

Various examples have been described. These and other examples are within the scope of the following claims.

1. A heterogeneous catalytic reactor, comprising:
an encasement having a length and a width, wherein the length extends from a distal portion of the encasement to a proximal portion of the encasement, and wherein the encasement defines an internal reaction volume;
at least one inlet in the proximal portion of the encasement, wherein the at least one inlet defines a reactant flow channel that is in fluid communication with the internal reaction volume of the encasement;
at least one conduit arranged within the internal reaction volume and extending from the proximal portion of the encasement toward the distal portion of the encasement, wherein the at least one conduit defines at least a portion of a return flow channel;
at least one outlet in the proximal portion of the encasement in direct fluidic communication with the at least one conduit, wherein the at least one outlet defines at least a portion of the return flow channel; and
at least two species of catalyst material positioned within the internal reaction volume.

2. (canceled)

3. The reactor of claim 1, further including one or more baffles extending into the internal reaction volume from the conduit.

4. The reactor of claim 3, wherein one or more baffles extend into a first portion of the internal reaction volume and one or more baffles extend into a second portion of the internal reaction volume, and wherein a total surface area of the one or more baffles extending into the first portion of the internal reaction volume is larger than a total surface area of the one or more baffles extending into the second portion of the internal reaction volume.

5. The reactor of claim 3, wherein one or more baffles extend into a first portion of the internal reaction volume and one or more baffles extend into a second portion of the internal reaction volume, and wherein a pitch of the one or more baffles extending into the first portion of the internal reaction volume is different than the pitch of the one or more baffles extending into a second portion of the internal reaction volume.

6. The reactor of claim 3, wherein the one or more baffles form a spiral shape along a length of the conduit.

7. The reactor of claim 1, wherein an inner lumen of the conduit includes one or more features for increasing fluidic convection in fluid traveling within the conduit or thermal conduction to the conduit.

8. (canceled)

9. The reactor of claim 7, wherein the one or more features are defined by an inner wall surface of the conduit or are defined by one or more structures positioned within the inner lumen of the conduit.

10. The reactor of claim 1, further including a filter positioned at a distal end of the at least one conduit, wherein the filter is configured to prevent catalyst material from entering the conduit.

11. The reactor of claim 1, wherein the return flow channel is devoid of catalyst material.

12. The reactor of claim 1, wherein catalyst material is packed within a distal portion of the at least one conduit.

13. The reactor of claim 1, wherein the at least one conduit includes a first conduit and a second conduit, wherein each of the first conduit and the second conduit define at least a portion of the return flow channel.

14-17. (canceled)

18. The reactor of claim 1, wherein a series of catalytic zones are arranged in a predetermined sequential order within the internal reaction volume along the length of the encasement.

19. The reactor of claim 18, wherein each catalytic zone includes only a single species of catalyst material that is dissimilar compared to the species of catalyst material found in other catalytic zones.

20-25. (canceled)

26. The reactor of claim 1, wherein the encasement is made of silicon carbide, a silicon carbide composite, alumina, silica, aluminum nitride, aluminum oxynitride, or a combination thereof.

27. (canceled)

28. The reactor of claim 1, wherein at least a portion of the at least one conduit is made of a ceramic material.

29-31. (canceled)

32. The reactor of claim 1, wherein at least the distal portion of the encasement or at least a distal portion of the at least one conduit are coated with a material selected from the group consisting of aluminide, alumina, an alumina/silicon carbide composite material, a boron nitride material, mullite, a silicon nitride material, a rare-earth silicate material, or a rare-earth aluminate material.

33. A method of producing a reaction product, the method comprising:
providing a heterogeneous catalytic reactor that includes an encasement having a length and a width, wherein the length extends from a distal portion of the encasement to a proximal portion of the encasement, and wherein the encasement defines an internal reaction volume;
at least one inlet in the proximal portion of the encasement, wherein the at least one inlet defines a reactant flow channel that is in fluid communication with the internal reaction volume of the encasement;
at least one conduit arranged within the internal reaction volume and extending from the proximal portion of the encasement to the distal portion of the encasement, wherein the at least one conduit defines at least a portion of a return flow channel;
at least one outlet in the proximal portion of the encasement in direct fluidic communication with the at least one conduit, wherein the at least one outlet defines at least a portion of the return flow channel; and
at least two species of catalyst materials positioned within the internal reaction volume.
establishing a thermal gradient along the length of the internal reaction volume of the encasement, wherein a temperature of the internal reaction volume defined by the distal portion of the encasement is higher than a temperature of the internal reaction volume defined by the proximal portion of the encasement;
directing the one or more reactants through the internal reaction volume towards the distal portion of the encasement, wherein the one or more reactants contact a first catalyst material and a second catalyst material and wherein the one or more reactants increase in temperature and the reaction product is produced as the one or more reactants progress along the length of the encasement;
directing the reaction product from the internal reaction volume defined by the distal portion of the encasement into the at least one conduit;
directing the reaction product along the return flow channel towards the proximal portion of the encasement, wherein heat is transferred from the reaction product in the return flow channel to the one or more reactants in the internal reaction volume as the reaction product is directed towards the proximal portion of the encasement; and
directing the reaction product out of the reactor through the at least one outlet.

34. The method of claim 33, wherein the one or more reactants include one or more of carbon dioxide, hydrogen, and methane.

35-36. (canceled)

37. The method of claim 33, wherein the reaction product includes one or more of carbon monoxide, hydrogen, and water.

38. The method of claim 33, wherein the temperature of the internal reaction volume defined by the distal portion of the encasement is between 750° C. and 1,400° C. after the thermal gradient has been established.

39-41. (canceled)
